(19) United States
(12) Patent Application Publication
(10) Pub. No.: US 2004/0186760 A1
(43) Pub. Date: Sep. 23, 2004

(54) System and method for sales and inventory reconciliation

(76) Inventor: Tracy Alan Metzger, Elmhurst, IL (US)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/802,558

(22) Filed: Mar. 17, 2004

Related U.S. Application Data
(60) Provisional application No. 60/455,290, filed on Mar. 17, 2003.

(51) Int. Cl. G06F 17/60; G06K 7/10

(52) U.S. Cl. 705/7

(57) ABSTRACT

Systems and methods are provided for transacting credit card payments, and reconciling inventory and cash transactions on moving vehicles, such as, in one embodiment, a passenger aircraft in-flight. The system employs a portable device for completing remote point of sale (POS) transactions. In one embodiment, the portable device is a personal digital assistant (PDA). The system includes an Internet portal in communication with a database for entering and storing pre-sale and post-sale transaction and inventory information, which may be used for reconciliation purposes, among other things.

### CROSS-REFERENCE TO RELATED PATENT APPLICATIONS

This patent application claims the benefit of U.S. Provisional Patent Application No. 60/455,290, filed March 17, 2003.

### BACKGROUND OF THE INVENTION

1. Technical Field

The invention relates generally to a system and method for sales and inventory reconciliation. More particularly, the invention relates to a system and method for facilitating business to business relationships between airlines and flight goods and service providers, such as caterers, through reconciliation of in-flight inventory and sales transactions.

2. Description of the Related Art

An employer reportedly invented the mechanical cash register in 1879 to prevent sales clerks from stealing. More than a century later, the problems of accounting for retail sales proceeds and inventory persist. Salespeople are entrusted with valuable merchandise and the proceeds from sales. Problems continue to arise in attempting to hold individual salespeople accountable for their transactions. Accounting problems are particularly noticeable in circumstances where salespeople must circulate among customers to transact sales, and where the transactions are conducted under time pressure. Both of these circumstances are often present when goods are sold on moving vehicles.

For example, airline attendants traditionally push a cart along a narrow aisle to visit each potential customer personally and attempt to sell food, beverages, entertainment and other products. Interruptions are frequent and the time permitted for selling is limited, especially on shorter flights. The customers almost always pay in cash, with correct change being expected in return. Perhaps as a result, airlines have reported difficulties in recording sales transactions from onboard sales of duty-free items, liquor, and headsets. Additionally, traditional inventory accounting methods do not appear to be practical under these circumstances and much lost inventory is never satisfactorily accounted for.

Traditional payment terminals such as POS terminals available from companies including Verifone, Hypercom, Ingenico, Schlumberger or Lipman are the standard in today's marketplace. These terminals, however, are basic in their operations and require specific skilled developers to modify terminal applications. New strides are being taken by the terminal providers to provide more robust development interfaces, but these devices are relatively new and unproven.

Personal digital assistant (PDA) devices such as the Pocket PC and Palm platforms are open development devices that have more flexibility to customize industry specific applications than is possible on the aforementioned traditional terminals. In addition, PDAs have a wider range of communication options available than do traditional terminals. These factors make PDAs more attractive to mobile users with specific industry related needs including payment acceptance capability.

Airlines are sensitive to the incremental profit added by on-board, in-flight sales. With current increases in the cost of security and decreases in the volume of discretionary air travel, some airlines may rely on the revenue from in-flight sales to keep flying. Assuming that a significant fraction of the in-flight sales revenue currently lost to theft could be accounted for and retained, millions of dollars per year might be saved. If the practice of selling in-flight meals separately from the ticket price becomes widespread, as current trends indicate, the potential for savings will be greater still.

Accordingly, a need exists for a new system for performing and recording transactions in connection with sales of products and/or services at a remote location, such as on a moving vehicle. A system that can be used on a moving vehicle to process credit transactions and track inventory would be welcomed. The system should be quick and convenient at the point of sale, easy to set up for use, and sufficiently accurate and tamper-proof to be relied upon for sales and inventory reconciliation and reporting.

### SUMMARY OF THE INVENTION

In accordance with the described embodiments, systems and methods are provided for transacting credit card payments, and reconciling inventory and cash transactions on moving vehicles, such as, in one embodiment, a passenger aircraft in-flight. The system employs a portable device for completing remote point of sale (POS) transactions. In one embodiment, the portable device is a personal digital assistant (PDA) running application software to adapt the PDA operating system to the particular applications of accepting payments and tracking inventory.

The system links the portable device to an operating system for a pre-sale or pre-flight configuration. The pre-flight configuration employs a personal computer-based terminal application program, which loads a base flight profile for each terminal into the respective portable device. Information in the base flight profile includes, for example, flight information and the catering menu items for a particular flight. In one embodiment, the pre-sale loading of a portable device is performed by a flight caterer, before a scheduled flight.

Subsequently, one or more flight attendants carry one or more portable devices with them as they circulate among the passengers to take food and drink orders during the flight. The device stores in its memory the type and quantity of selected items for each sales transaction with each of the passengers. After all transactions are completed, the device is linked to a terminal for post-flight synchronization, which enables various system users to reconcile inventory items and transaction payments with device sales transaction information.

### BRIEF DESCRIPTION OF THE DRAWINGS

FIG. 1 illustrates a high level diagram of the sales and inventory method, showing the relationship between the system users;

FIG. 2 illustrates a combined system block diagram and method steps in accordance with the method illustrated in FIG. 1;

FIG. 3 illustrates an exemplary portable terminal device for use with the system illustrated in FIG. 2;

FIGS. 4A and 4B illustrate block diagrams illustrating the use of the portable terminal device;

FIGS. 5A through 5G illustrate exemplary screen duplications in accordance with the portable terminal device block diagrams of FIGS. 4A and 4B;

FIG. 6 illustrates an exemplary Internet portal map for the system shown in FIG. 2;

FIGS. 7A through 7G illustrate exemplary screen duplications of portal pages in accordance with the Internet portal map of FIG. 6;

FIG. 8A illustrates an exemplary screen duplication of a portal page showing a credit card report with card authorization and settlement; and

FIG. 8B illustrates an exemplary screen duplication of a portal page showing the detail of one credit card transaction in accordance with the report of FIG. 8A.

### DETAILED DESCRIPTION

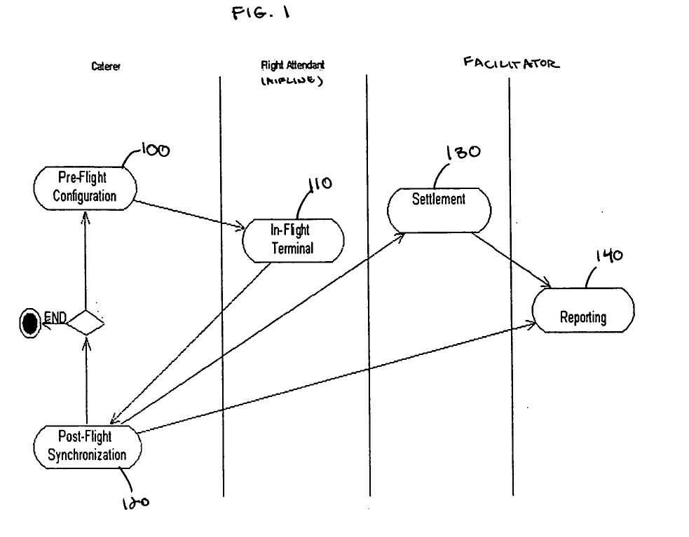

Referring now to the figures, a system and method for sales and inventory reconciliation is described. In one exemplary embodiment, the system and method facilitates business to business (B2B) relationships between a flight caterer and one or more airlines having a plurality of flights with predetermined schedules, among other things. As described hereafter in further detail, a B2B relationship facilitator provides a web portal and portable device which promote reconciliation and accountability of catering and other flight inventory, as well as a means for completing and reconciling in-flight sales transactions by accepting cash payments, credit card payments, among other forms of payment. FIG. 1 illustrates a method and relationship between the caterer, airline, and facilitator. As shown, the method includes a pre-flight configuration 100, in-flight terminal transactions relating to sales and inventory 110, post-flight synchronization 120 of the in-flight portable terminal device, sales transaction settlement 130, and reporting of sales and inventory information from the portable terminal device 140.

Before a flight, the portable device is linked to a user interface terminal, typically at the catering kitchen, for receiving a pre-flight configuration 100. The pre-flight configuration loads a base flight profile for each flight on which the device is to be used. Information in the base flight profile includes, for example, flight information and the catering inventory items for a particular flight. The pre-sale loading of a portable device may be performed by a flight caterer, before a scheduled flight. The caterer then delivers the device and catering inventory items to the aircraft.

In flight 110, the customer may select to pay for items using cash or by credit card. Means for swiping and authorizing credit cards is included with the portable device. In a preferred embodiment, a magnetic-strip reader is coupled to the device. A printer is also provided with the device for printing a receipt or other record of the transaction.

During the post-flight synchronization 120, stored data from the portable device memory is loaded into a user interface terminal by use of a personal computer-based application program, ideally the same application program and type of terminal that was employed for the pre-flight configuration. The terminal routes the data to a back-office subsystem for archiving in a database and subsequent reporting of sales and inventory data, as well as completion of non-cash sales transactions. The device may then be cleared of data and prepared for use onboard another flight.

The back-office subsystem enables settlement of the transactions 130 with a financial processing network, and settlement results are received and stored in the database. A report server is linked with the database to access sales, transaction, and inventory data for creation of various reports 140, thereby enabling multidimensional data analysis (e.g., trending) of multiple airlines, flights and catering locations, among other things.

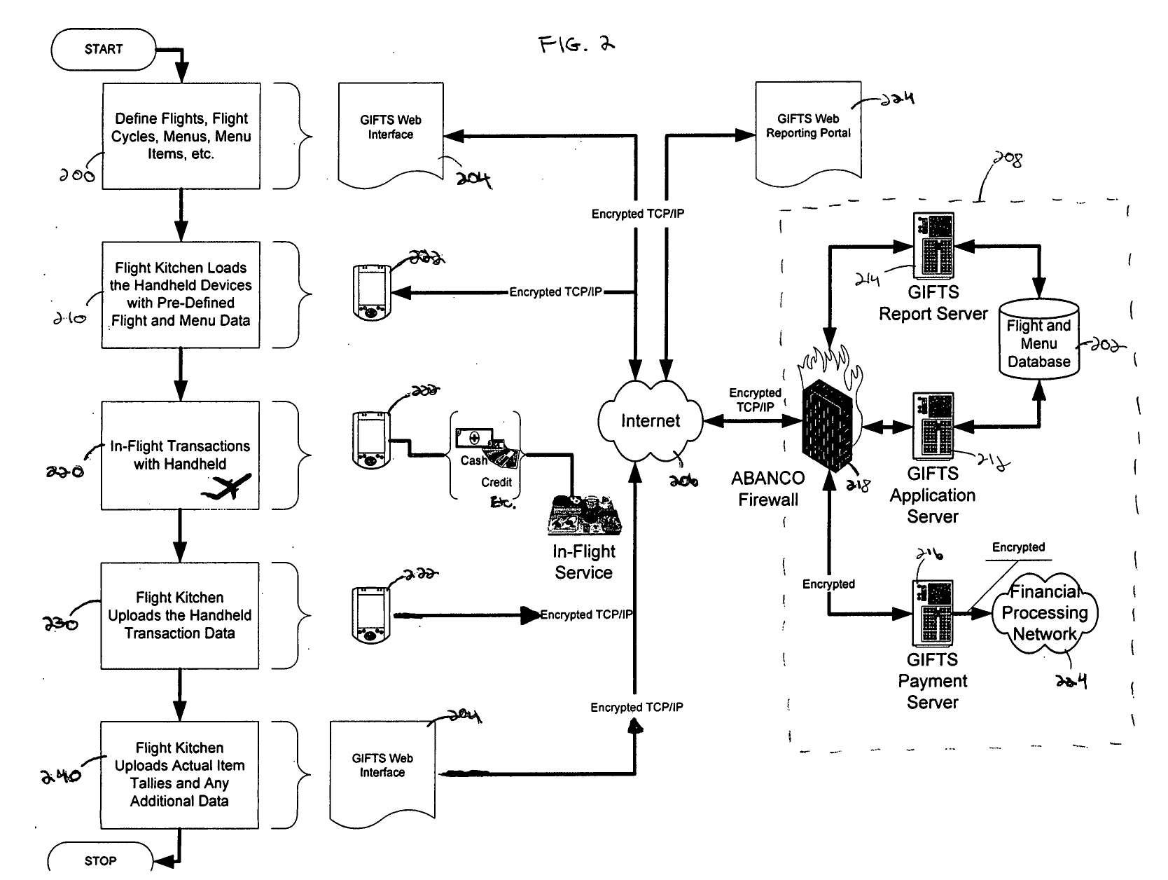

Referring now to FIG. 2, a combined process flow and system block diagram further illustrates the method of FIG. 1. The process starts at step 200 with the facilitator creating caterer and airline accounts with provided scheduled flight data and data comprising a master list of items, which may be sold. The items may comprise food items, beverage items, duty-free items, and a number of durable goods and/or services to be offered to flight passengers by airline or caterer partners. The facilitator associates a subset of the master item list with each scheduled flight, thereby creating a relationship between the caterer and airline, and provides an estimated starting inventory count of the items in the subset. The estimated starting inventory count may be provided by the caterer and/or airline, or alternatively, may be calculated relative to historical data which accounts for sales trends, passenger demographics, number of passengers onboard, and item spoilage, among other things. The facilitator enters and stores the aforementioned flight schedules, item lists, estimated starting inventory counts, and other data into a database 202 through use of a user interface 204. The user interface 204 communicates with the database 202 through a network such as the Internet 206 via an Internet portal. The portal may be physically embodied by a facilitator's back-office subsystem 208 comprising one or more servers, such as, for example, the illustrated application server 212, report server 214, and payment server 216. Additionally the subsystem 208 may include a firewall 218 or other security means known in the art. The subsystem 208 may include, for example, a Microsoft Internet Information Server platform utilizing the Microsoft ASP.NET framework. Additionally, the subsystem 208 may include, for example, a database management system, such as the SQL Server Enterprise Edition available from Microsoft.

After the initial creation of accounts 200, at the flight's origination caterer, the caterer accesses the portal in step 210 for configuration of one or more portable terminal devices 222 to be transported with the catering items onboard the flight. The originating caterer may wish to perform a physical inventory and/or assessment of the items prior to loading the items comprising the catering inventory on the flight. The caterer may then enter the data resulting from the origination physical inventory into the portal. In this way, the starting inventory of items is verified pre-flight. As shown, the one or more devices 222 are configured via communication with the portal, the configuration being relative to one or more pre-scheduled (and pre-defined) flights selected by the caterer, and the entered inventory data associated with those flights. The devices 222 may be linked to the portal by way of an origination user interface 204, such as an Internet enabled personal computer with access to the portal, or other communication means known in the art. In this way, the portal may download or push configuration data to the devices 222.

The devices and catering inventory are delivered to the corresponding flight (i.e., boarded). One or more flight attendants may again perform an onboard pre-flight physical inventory of the received catering inventory. The devices 222 may be updated with data from the onboard pre-flight inventory. In this way, the onboard flight crew may determine if the count of items is consistent with the caterer's count. If the counts do not reconcile, this may provide an indication to the caterer and/or airline that items are being miscounted by the origination catering staff, stolen by delivery personnel, ground crew, or the like. In flight, the flight attendants complete sales transactions with consumers (i.e., passengers) with the one or more devices 222 in step 220. The flight attendants provide passengers with in-flight service, in which they may sell items from the catering inventory (e.g., food and beverages) as well as other items such as headsets and other items including goods and services that the consumers may receive at the end of the flight (e.g., duty-free items, admission to attractions at the flight's destination location, etc.) The sales transactions may be completed with the devices 222 by accepting cash, credit card, debit card, smart card, coupons, frequent flier awards, comps (i.e., complimentary items given to passengers at the flight attendant's discretion), or other known form of payment. The devices 222 account for the sales transactions including the quantities of items sold and payments. The flight attendants may swipe a card, such as a credit card, for example, as payment, capture an authorization signature, and print a receipt. Additionally, the devices 222 may allow the attendants to accept returned items and account for return of cash or crediting of a swiped card. Moreover, the devices 222 allow attendants to perform in-flight and/onboard reporting such as, for example, account for change due to passengers, sales totals, flight attendant itemized sales transactions, among other things. The one or more devices 222 may communicate with each other in-flight via various communication means such as infrared, wireless, etc., to maintain, for example a master inventory of onboard items. It is contemplated that the devices 222 may include input devices such as optical (i.e., bar-code) or RFID scanners, and if the flight is equipped with a suitable communication means to the Internet, the devices 222 may be operative to communicate with the portal in real time to authorize and settle non-cash sales transactions, among other things such as real-time inventory or sales reporting.

At the end of the flight, the devices 222 and catering inventory are unloaded (i.e., deplaned) and delivered to the destination caterer. The destination caterer may be the same as the origination caterer, since, often, a flight caterer is an organization with a plurality of geographically distributed flight kitchens. Alternatively, the destination caterer may be different from the origination caterer and have a relationship or reciprocal agreement with the origination caterer. In step 230, the destination caterer links the received devices 222 to the portal by way of a destination user interface, such that the in-flight sales transaction and inventory information may be communicated to the portal and recorded to the database flight record. Similar to the pre-flight, originating caterer activities, the destination caterer may perform a post-flight inventory of the catering inventory items in step 240. The destination caterer accesses the portal and selects the appropriate flight for updating the database record for that selected flight, and enters the post-flight inventory data. The destination caterer may then return the devices 222 to the originating caterer, or alternatively, configure the devices for a return flight to the originating caterer or other selected flight.

The portal, in receipt of the device information by way of the destination caterer, updates the flight database record of the completed flight with inventory and transaction information. Transaction information relating to non-cash transactions is routed to a payment server 216, which is in communication with a financial processing network 224 (e.g., ACH) for transaction settlement and payment receipt (e.g., electronic finds transfer). The payment server 216 then communicates with the database 202 to update the flight database record with settled and paid transaction data to complete the flight database record. Thereafter, a complete flight database record comprising inventory information and transaction information is available to the caterer, airline, facilitator, or other authorized system user. A user may access the portal for reporting of the database data by, for example a reporting portal 224. As such, a report server 214 may communicate with the database 202 for serving predetermined and customized, ad hoc, or other reports relative to the user's role and affiliation. The report server may serve customized single or multi-dimensional views of requested data. Additionally, the report server 214 may deliver reports in a number of formats via a number of communications means. For example, the report server 214 may generate various reports in HTML, XML or delimited formats for downloading and/or printing via the portal. The report server 214 may also be operative to encrypt reports, for example with PGP private key encryption, such that the report may be emailed or ftp'd to an authorized or key-holding recipient.

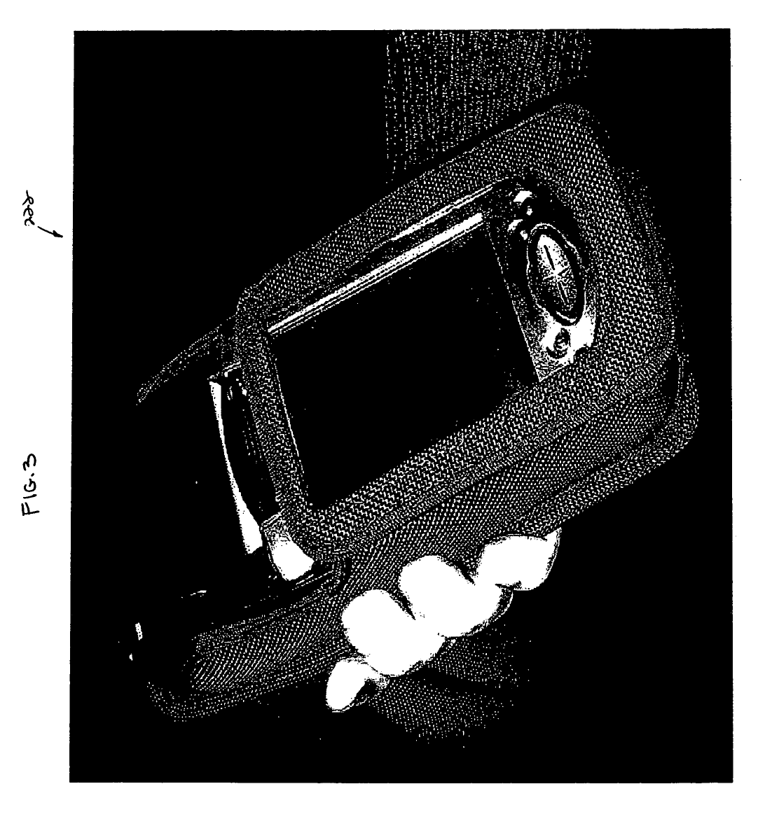

Referring now to FIG. 3, an exemplary portable terminal device 222 is illustrated. As shown, the portable terminal device includes a touch screen user interface, a printer such as a thermal printer, and a magnetic strip card reader for swiping a credit card, flight attendant ID card, frequent flier card, or the like. The portable terminal device may be an available off-the-shelf device such as a personal digital assistant (PDA) running point of sale (POS) like software, which is operative to record sales and inventory transactions among other things. Exemplary PDAs for this system and method include a number of Hewlett Packard's iPAQ pocket PC devices. To accomplish receipt printing and card swiping, the iPAQ device may be coupled to a detachable combination printer/card reader module such as, for example, those available from Infinite Peripheral Inc. As previously mentioned, the terminal device may include a bar-code scanner for in-flight item scanning. The terminal device should be operable to communicate with other terminal devices, peripherals, and other devices via wireless communications including, for example, infrared, Bluetooth, 802.11 Wi-Fi, among others. In this way, multiple terminal devices may communicate with each other in-flight for inventory purposes, and the like. For example, one terminal device (such as a device used in the aircraft first class section) may be designated as the master device and keeper of a master inventory item list. The remaining terminal devices (such as those in coach class) may be designated as slave devices and may communicate with the master device to update the master inventory item list as transactions are completed. Moreover, such a master/slave relationship may facilitate the tracking of catering inventory items transferred between flight attendant carts and subsequent inventory reconciliation.

It is contemplated that the aforementioned method and system may vary slightly due to differing business practices and requirements of the one or more airlines utilizing the system. For example, in one embodiment, the airline and caterers utilize the Internet portal that is provided by the facilitator. The portal environment is utilized to change menus, menu item pricing, update flight schedules, among other things. The origination caterer updates flight information including boarding quantities, starting cash, and passenger counts in the portal. The POS device is configured prior to each flight with the scheduled flight and menu information through an Internet connection via a Microsoft ActiveSync and USB connection. The caterer may also be responsible for ensuring that the POS device and peripheral printer is fully charged and stocked with paper for receipt printing. The caterer prints an inventory sheet from the portal and places it with the POS device and merchandise carts to be delivered to the aircraft. The caterer may provide a starting “cash bag” or envelope with a predetermined amount of cash (e.g., thirty dollars in one dollar bills) for making change onboard the aircraft. The device, cash, inventory sheet and merchandise are sealed in a container (e.g., the merchandise cart) and delivered to the aircraft.

A flight attendant onboard the aircraft signs for the delivered merchandise, cash and devices after breaking the seals and verifying correct cash and inventory counts have been delivered. The flight attendant activates the device and swipes an employee ID card or badge through the device's card reader for authentication purposes. The attendant then prepares the cart for selling the merchandise. In flight, the attendant passes through the aisles with the cart, transacting sales and recording sales information with the device on a per customer basis. Transactions may be completed with cash, credit card, and other forms of payment. A signature may be captured for transactions over a predetermined amount (e.g., twenty-five dollars) to protect against chargebacks during later processing and settlement (e.g., store and forward processing). The attendant may provide a receipt for all credit card sales and upon request for cash sales. If change cannot be made for a customer at the time of sale, the attendant may utilize a change due transaction flagging functionality of the device to record a seat number and/or name to capture the amount of change due. After all sales are transacted, the attendant may display and/or print an in-flight change due report that shows which customers are due change and how much. The attendant may then go through the aircraft cabin providing change.

After the attendant has offered all customers their choice of merchandise, they may then have the opportunity to purchase any perishable merchandise at a discount. This discount may be offered to pilots, or aircraft employees or personnel onboard. The employee must swipe an ID to receive the discount. The POS device may include a discount functionality that may be used to complete such transactions.

After all sales are completed (customer and employee) the attendant may print out an attendant report, which shows by employee number, the quantity of each item sold and the price. A summary report may be printed, which shows by device sales totals by payment type (cash, credit card, coupon, discount, etc.). The attendant is then responsible for ensuring that the cash reconciles with the reports. If it does not reconcile, the flight attendant may write notes on the reports or on the inventory sheet. The cash is then placed in a tamper-proof bag or container with any transaction receipts and the reports. The device may be turned off. The devices and cash are then stored and sealed in a cart with the unsold merchandise. The seal numbers may be recorded on the inventory sheet for delivery to the destination caterer.

The cart is received by the destination caterer where the seal numbers are verified and the seals are broken. The caterer then sends the cash to be counted and reconciled. The POS devices are cradled and synchronized via a Microsoft ActiveSync and USB connection to the Internet. Sales transaction information is uploaded from the device to the portal for the completed flight. The caterer then counts the remaining unsold merchandise in the card and inputs that inventory into the portal. In this example, a flight may not be closed out until an ending inventory is entered. The caterer and airline may employ a third part clearing house, which deposits the received cash in the caterer's account and thereafter removes the airline's sales proceeds (e.g., from liquor and headset sales) from the caterer's account and deposits or transfers money to the airline's account based on POS device sales information. The third party may process (e.g., authorize and settle) the credit card transaction information according to the POS device information. The facilitator also utilizes the data upload from the POS device for caterer and airline reporting purposes. Data is processed, formatted, archived and the like by the facilitator, and is made available via an encrypted and secure portal where a file relative to the closed out flight may be pulled and inserted or placed in an airline database for reporting purposes. Alternatively, the data may be sent via a B2B feed rather than pulling it from the portal.

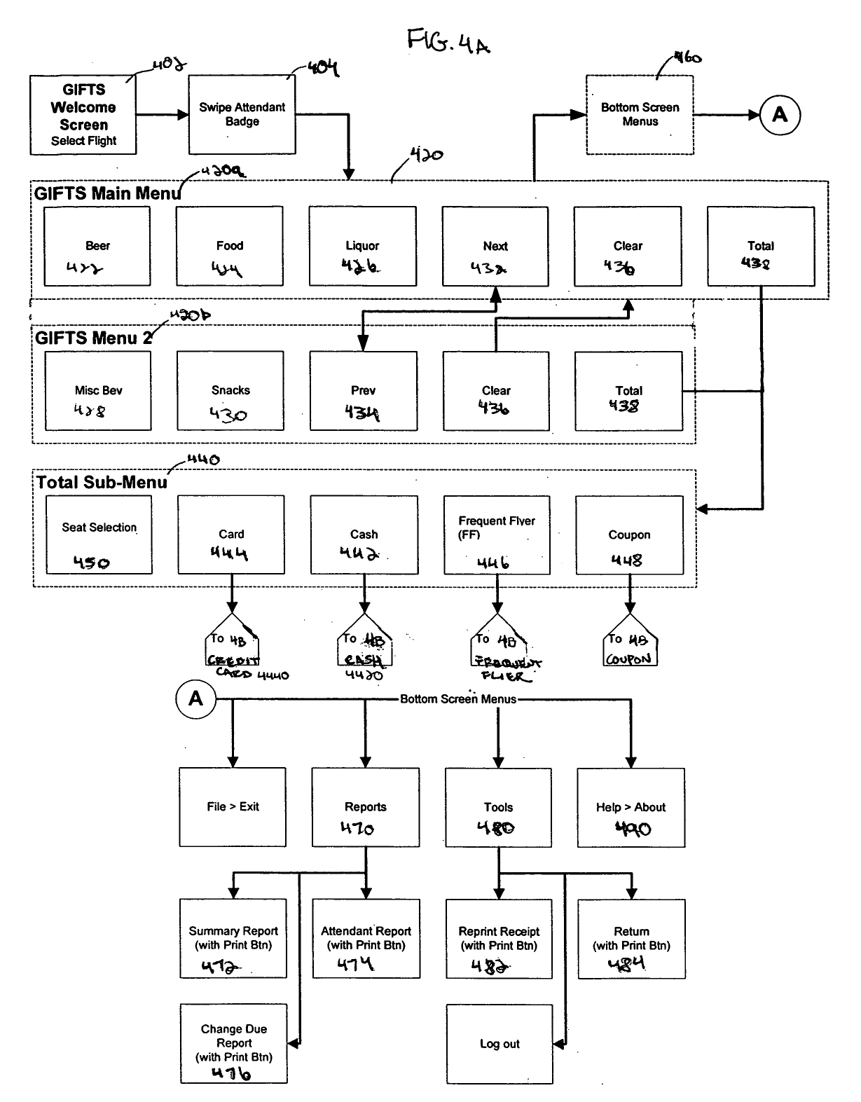

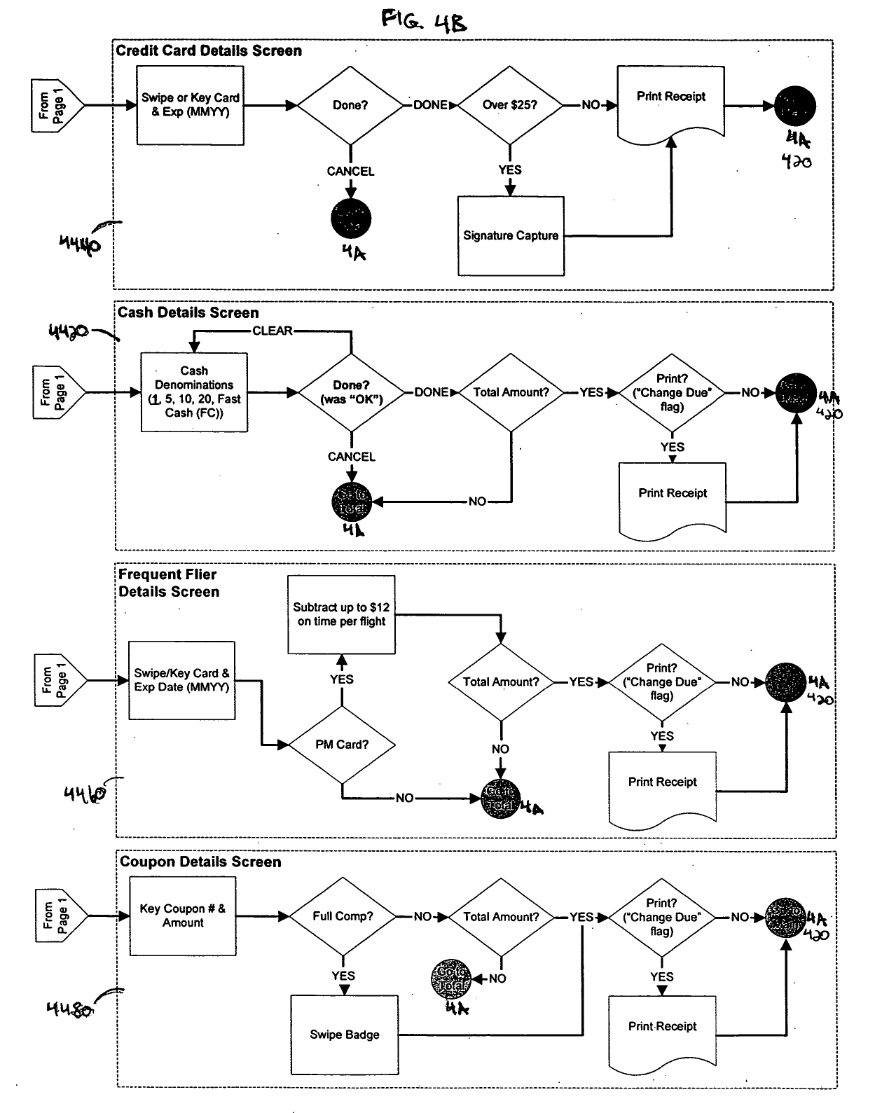

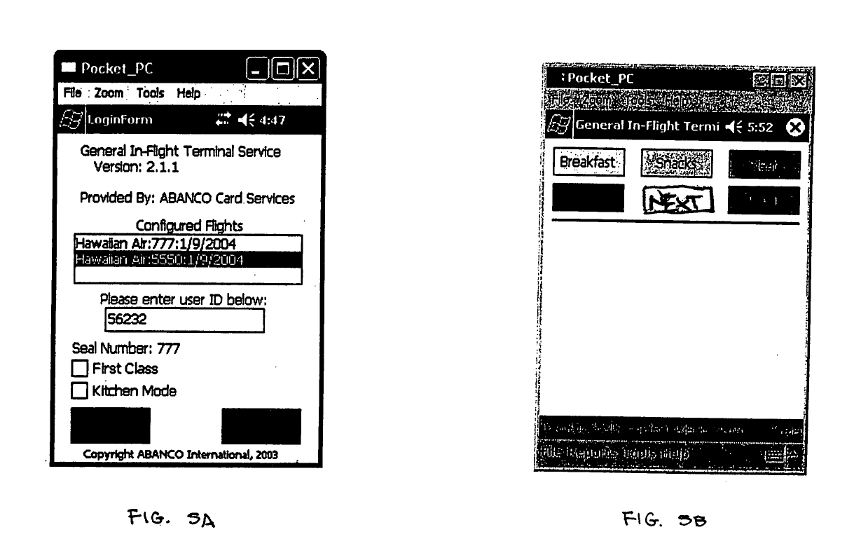

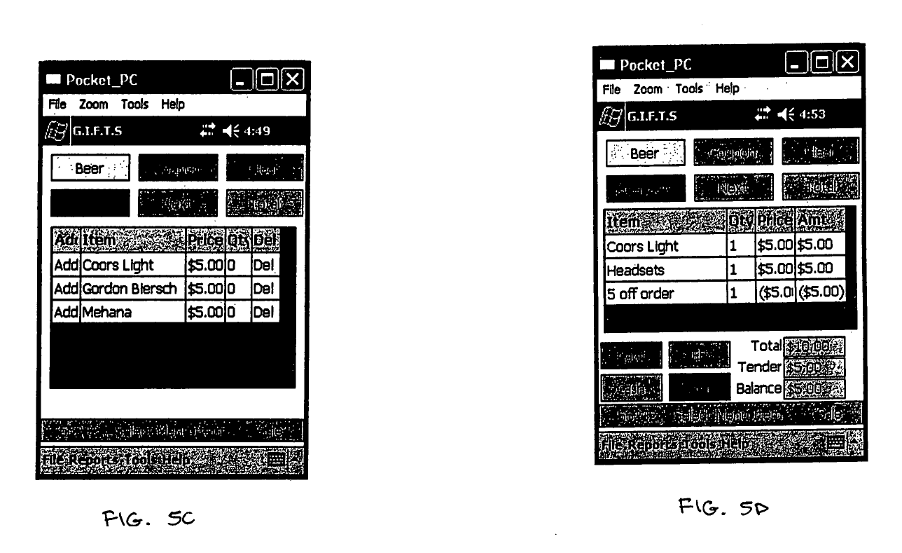

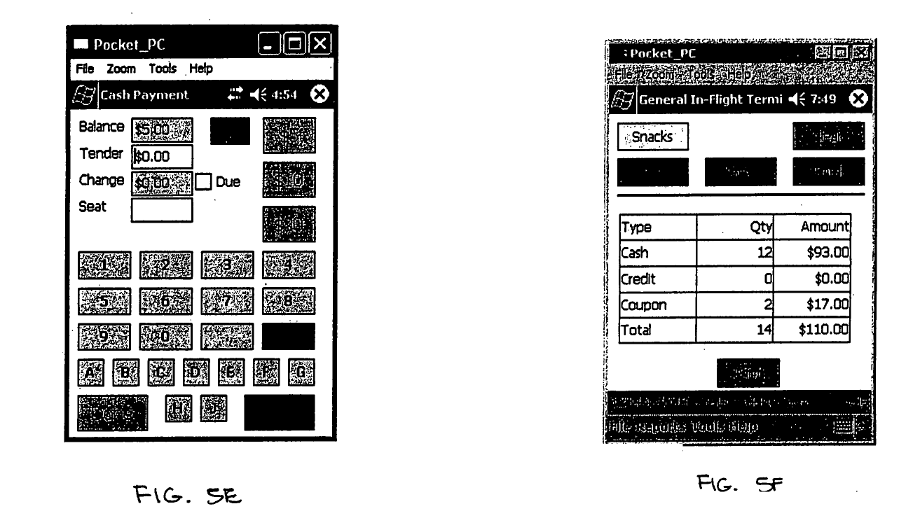

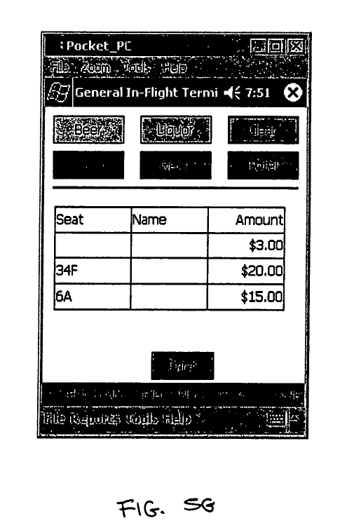

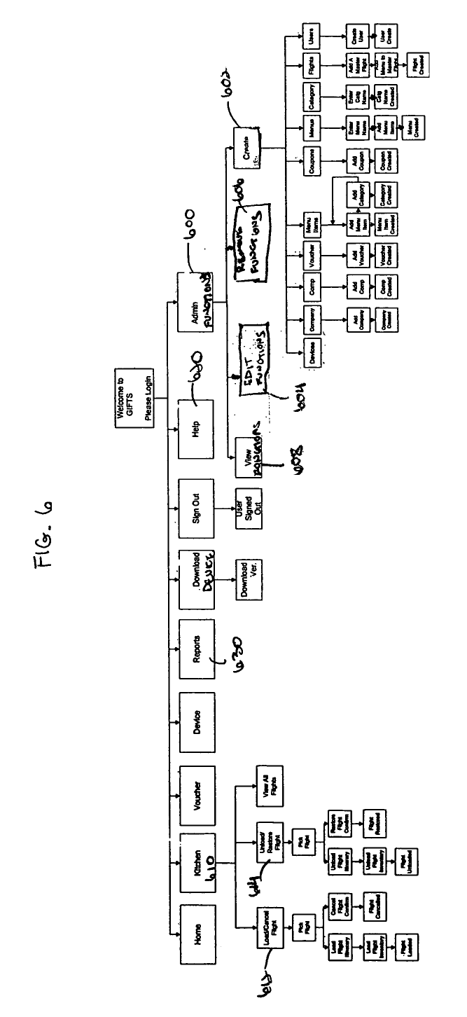

Referring now to FIGS. 4A and 4B, the portable terminal device user interface is described. The user interface is designed to facilitate quick transactions with the customers. As shown in FIG. 4A, the software user interface is realized by the installed flight terminal (POS-like) software application. The user interface comprises a number of menus with touch-selectable buttons. When the application is initiated, the user interface may display a welcome screen in block 402. For a flight attendant or other user to operate the device, they must first be authenticated or verified as an authorized user by swiping an ID card, entering an identifying PIN code or the like in block 404. One exemplary authorization screen is illustrated in the screen duplication of FIG. 5A. Also as shown in FIG. 5A, the device may be configured with more than one flight, and if more than one devices are used on a flight, one may be designated as the “first class” (e.g., master device as previously discussed). Typically, first class passengers do not purchase items, but instead receive them as complimentary or included in the price of their ticket. Therefore, the first class device is primarily used for inventory accounting purposes, and not payment processing.

Now, authenticated, the attendant is presented with a main menu 420, and bottom screen menu 460. As shown, the main menu 420 includes a number of selectable buttons, which, when selected display various item lists for, for example, beer 422, food 424, liquor 426, miscellaneous beverage 428, snacks 430, among other things. As shown, the main menu 420 may be segmented into two menus, 420a, 420b, which are selectable by pressing the next 432 and back 434 buttons. Additionally, the main menu 420 may include buttons to clear a transaction 436, and to total a transaction 438 prior to collecting a sales transaction payment. One exemplary main menu 420 screen is illustrated in the screen duplication of FIG. 5B. As previously described, the user interface is customizable relative to the airline and flight. For illustrative purposes, it will be understood that the user interface screen of FIG. 5B is for a flight where the airline wishes to have the caterer offer breakfast items, but not beer and liquor. Menu buttons comprising item categories may be added, deleted or edited as desired to conform to airline and/or caterer requirements for each flight.

By selecting buttons of the main menu 420, the attendant is presented with selectable lists of items in that category. For example, by pressing the beer button 422, the device will display a selectable list of various beers on the touchscreen display. One exemplary beer menu 422 screen is illustrated in the screen duplication of FIG. 5C. As shown, the attendant is presented with a list of selectable beers that may be added to an electronic-type “shopping cart” known in the art by selecting the “Add” button associated with each item. Errors in adding items may be corrected by observing the quantity field and selecting the “Del” button. Main menu buttons are displayed such that the attendant may easily jump from one category to another. For example, after selecting one or more items from the beer category, the attendant may select a headset or other item as the consumer desires.

As shown in FIG. 4A, by pressing the total button 438, the attendant is presented with a total sub-menu 440, which may include buttons for cash 442, card (e.g., credit, debit, etc.) 444, frequent flier 446, coupon 448, and seat selection 450. Upon pressing the total button 438, the device will display a screen listing the selected items in the consumer/passenger's “shopping cart”. One exemplary total screen is illustrated in FIG. 5D. At this point, the attendant may display the list of items to the consumer for verification purposes and query the consumer for method of desired payment. As illustrated, any coupons, comps, discounts, etc. are displayed to show the gross amount due and net amount after discounts, thus facilitating payment reconciliation. Flow diagrams illustrating completion of sales transactions relative to the total sub-menu 440 buttons are shown in FIG. 4B.

Referring now to FIG. 4B, completion of sales transactions is discussed. If the consumer wishes to pay for the selected sales transaction by cash, the attendant selects the cash button 442 and follows the cash flow diagram 4420. The attendant receives payment and records it in the device. If necessary, change is provided to the consumer and a receipt may be printed. If the attendant is unable to make change, a change due flag is set. Alternatively, the attendant may return to the total screen to remove items, add items, or edit item quantities, apply coupons, comps or other desired activity before collecting payment. If the consumer wishes to pay for the selected sales transaction by credit or other card (e.g., debit, smart card, etc.), the attendant selects the card button 444 and follows the diagram 4440. The card is swiped and the consumer may be required to sign a paper receipt, or alternatively, the device may be used to electronically capture the cardholder's signature if the sale transaction total is over a predetermined amount (e.g., twenty five dollars). A receipt is then printed for the consumer. The device may include data relative to acceptable and/or “blacklisted” cards for comparison to swiped card information. The results of this comparison determine whether the device accepts the payment or immediately voids the sale. Alternatively, in cases where the device is connected to a network or an Internet link at the time of the sale, the device may reject, or authorize and settle the credit card payment transaction. Diagrams 4460 and 4480 may be followed for completion of transactions for frequent flier rewards and coupon/comps respectively. One exemplary sales transaction completion screen for a cash transaction is illustrated in the screen duplication of FIG. 5E. As shown, the attendant may enter predetermined amounts (e.g., $5, $10) or select a button for an express checkout (e.g., button QC) as well as check a box for flagging the transaction as “change due” with an identifying seat number. For comps, the attendant may need to swipe an ID or enter an identifying PIN code or the like such that the airline and/or caterer is able to account for comped items, and the corresponding attendant comping the items for inventory and accountability purposes. Items may be comped for a number of reasons including passenger/customer inconvenience (e.g., due to flight delays), honeymooning couple, unaccompanied minor traveler, or other reason at the discretion of the attendant.

Referring back to FIG. 4A, the bottom screen menu 460 is described in further detail. As shown the bottom menu 460 may comprise a number of selectable items including reports 470, tools 480, and help 490 among other things, such as a means to exit the POS application. The device may be operable to run a number of onboard/in-flight reports on the transaction data collected by the device. For example, the device may provide a summary report of all device transactions, which may show type of payment, number of transactions per payment type, and total dollar amount per payment type. By pressing button 472, the attendant may view an exemplary screen as illustrated in FIG. 5F. The displayed transaction information may be printed for later use by the caterer or others. Additionally, by pressing button 474, the attendant may view a detailed itemization of transactions by attendant. For example, more than one attendant may utilize a single device and identify themselves prior to each transaction for tracking purposes. Additionally, if master and slave devices communicate in flight, sales transaction information may be aggregated on the master device and the itemized report may list transaction breakdowns by attendant ID and/or device ID. By pressing button 476, a change due report may be generated. One exemplary change due report is illustrated as a device screen duplication in FIG. 5G. As illustrated a change due amount may be associated with a seat number and/or name. Additionally, check boxes may be provided for accounting purposes to ensure that each customer is provided with the change due them.

By pressing the tools button 480 of FIG. 4A, the attendant may perform actions such as reprint a transaction receipt 482, print a blank receipt, accept returned items for refunds 484, among other things, such as user log in/out, synchronize the device to the portal. The receipt produced by the device contains information about the flight such as, for example, one or more of the following or any combination thereof including: flight number, originating airport, departure time and date, destination airport, arrival time and date, supplying caterer, the POS device identification (ID) number, attendant identification number, transaction number, and a selectable logo image. The printed receipt also preferably lists the items sold by type and cost, the sales tax (if applicable), and the total cost of the transaction. If payment is in cash, the printed receipt may show the amount tendered and the change returned. If payment is by credit card or debit card, the printed receipt may show the name of the card holder, the type of credit card used, significant card numbers, and the expiration date. Returned items are accounted for through the return functionality of the device via button 484. As with sales transactions, the device may require that the consumer returning the item provide a signature for electronic capture and/or attendant authentication/verification to ensure that fraud cannot occur. This return functionality provides for monetary and inventory accountability among other things.

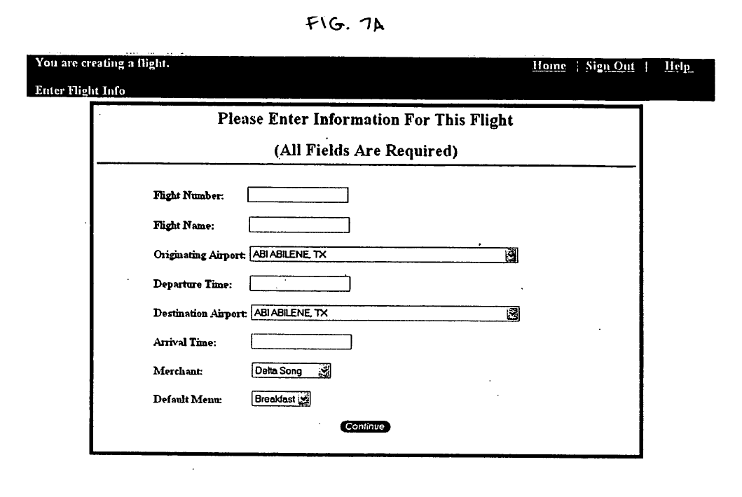

Referring now to FIG. 6, an exemplary portal map for the system is shown and described. As is known, the exemplary portal may employ role-based security access criteria to permit and restrict access of various users to portal functional areas. For example, in one embodiment, all authorized users are able to access help 620 and reports 630. Further, ranging from lowest to highest security access are the following: flight attendant, kitchen user, kitchen supervisor, airline administrator, kitchen administrator, help desk, and facilitator administrator. At the caterer (i.e., Kitchen 610) , there are security levels with varying levels of portal access including: kitchen user—lowest access level for loading 612 and unloading 614 a flight's itinerary and inventory, kitchen supervisor—for creating a flight exception (e.g., cancellation, schedule and/or catering inventory change), and kitchen administrator for creating and maintaining the catering inventory among other things. Similarly, the airline administrator may create and edit flight schedules, while the facilitator's help desk personnel and administrator may create, maintain and assist the caterer and airline users. Preferably, the portal is operable to manage a plurality of concurrent caterer and airline users as well as configure and communicate with a plurality of terminal (POS) devices. To that end, the portal must provide sufficient bandwidth for the plurality of users, particularly at peak times. Moreover, the portal should be highly stable with minimal (or no) downtime, thereby enabling twenty-four hour, seven day per week operation.

As shown, administrative functionality 600 makes up a large portion of the portal. Administrative functions include creation 602, editing 604, removal 606, and viewing 608 functions. Administrative functions are generally performed by the B2B facilitator, however, limited administrative functions may be granted to caterer personnel and/or airline personnel as mentioned above for creation, modification, and/or removal of role-specific items. Administrative functions are used to setup, maintain, and audit the core data and functional parameters of the system. As previously mentioned, the facilitator establishes the relationship between the caterers and airlines by entering or creating company accounts. Thereafter the various administrators may create flight schedules for a plurality of scheduled recurring flight events, a master list of items, which may be categorized (e.g., food, beer, liquor, snacks), a “menu” comprising a subset of the master item list, which may include one or more categories, coupons, comps, and vouchers, among other things as shown in the sub-blocks under the create main block 602. The foregoing data is entered into the portal and written, inserted, or otherwise saved in the database 202. Data should be retained in the database for an adequate amount of time (e.g., twenty-five months) to provide various trending reports, etc. to the users.

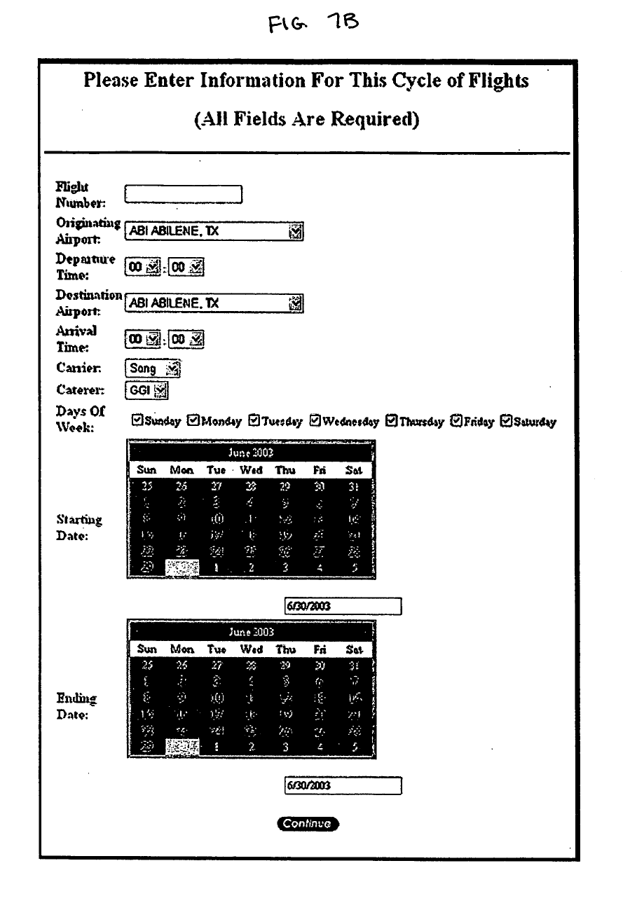

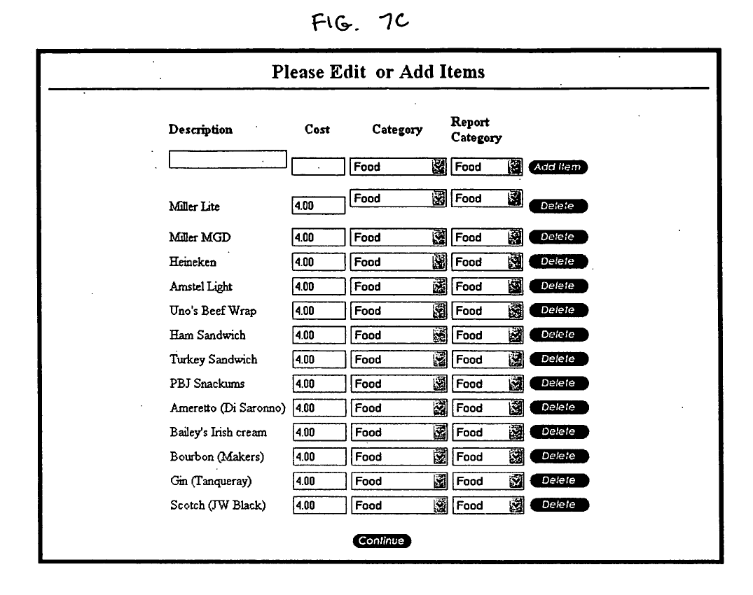

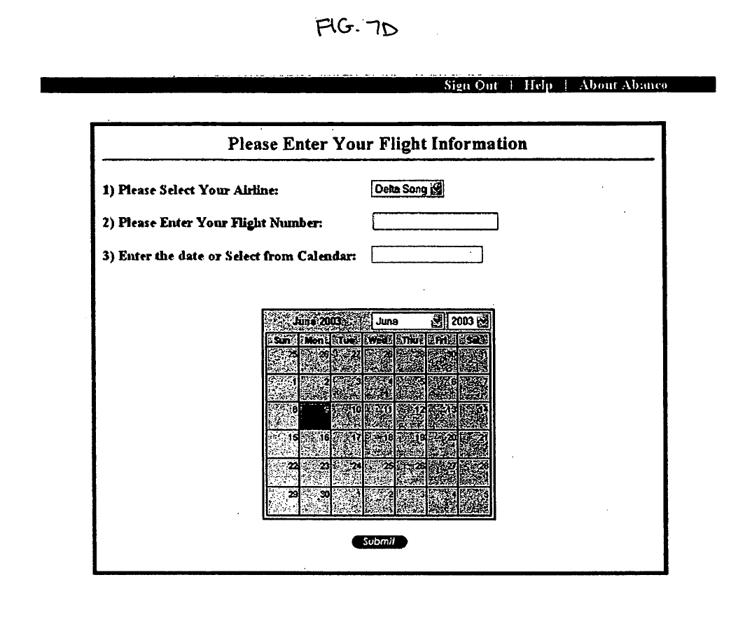

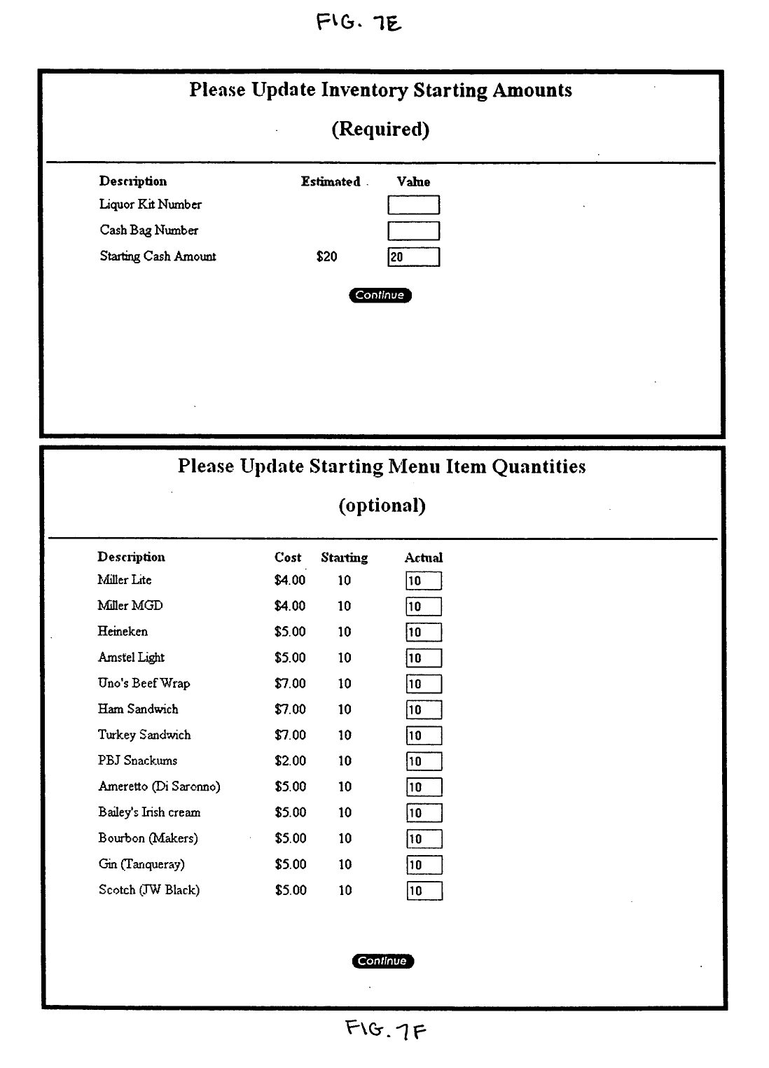

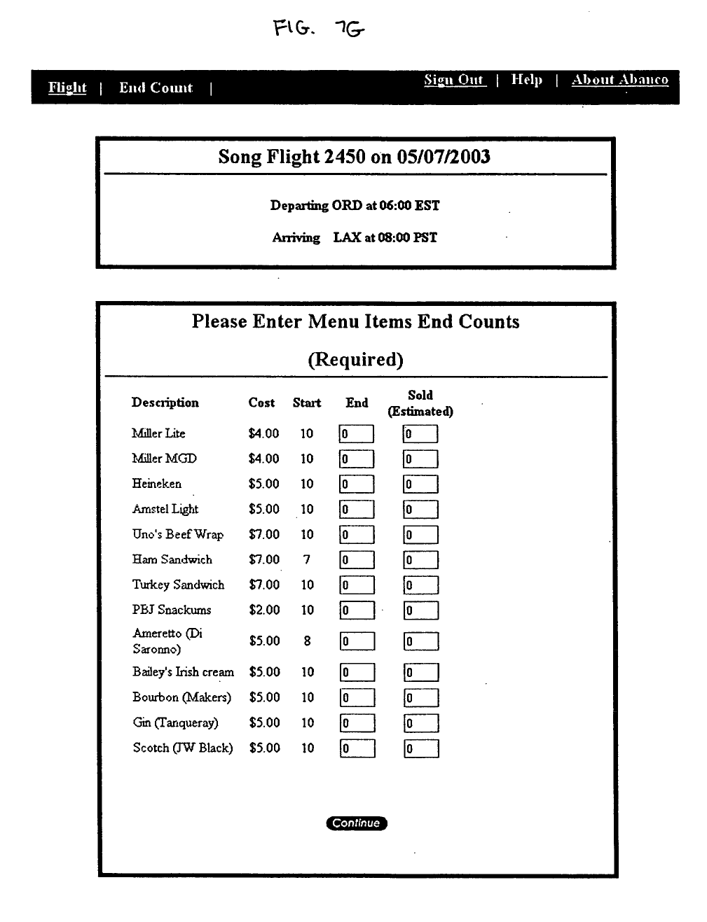

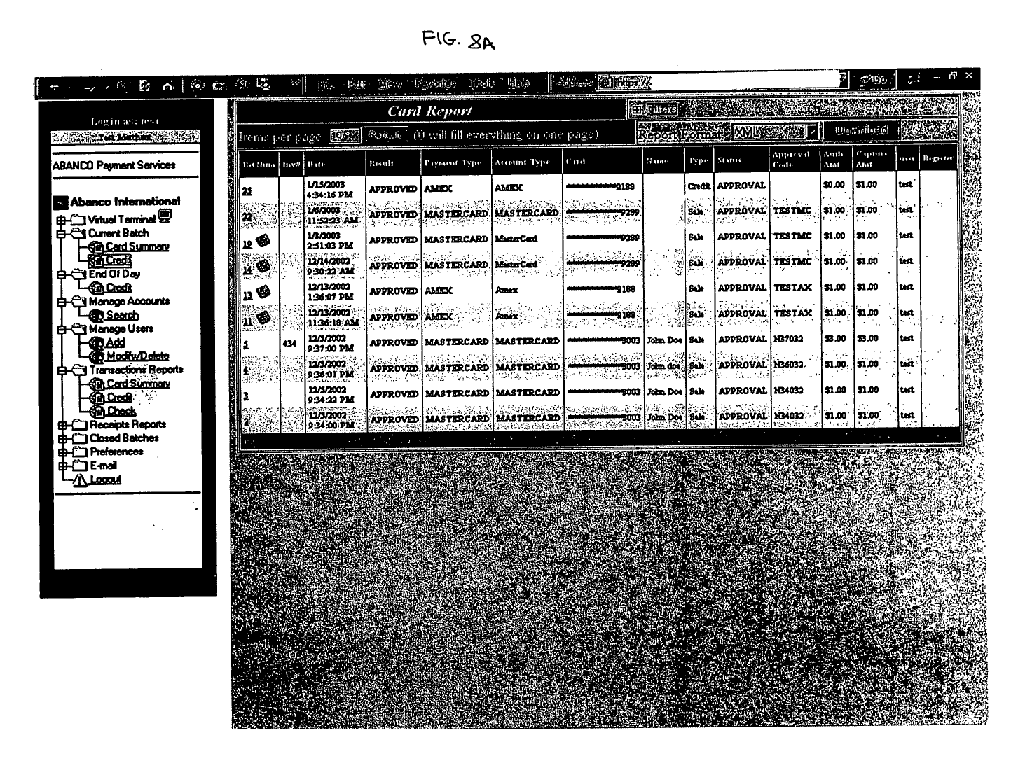

One exemplary portal page illustrative of administrative creation of a flight is shown in FIG. 7A. As shown, the administrator enters a flight number, name, originating airport and departure time, destination airport and arrival time, the flight carrier (i.e., company) and default catering menu for association with the flight. The flight may be characterized as one time, periodic, cyclic, recurring, or other. Referring now to FIG. 7B, a recurring flight may be entered by use of the illustrated exemplary portal page. The recurring flight may be defined as having a daily schedule between a starting and ending date as shown. Associations are created in the database 202 between a flight event and items to be offered during that event such as a catering “menu” among other things. Referring now to FIG. 7C, a catering “menu” for a flight may be defined and/or edited by way of the exemplary illustrated portal page. Individual items may be added or edited, each item having a cost and one or more categories for in-flight and reporting purposes. As necessary, the database entries may be viewed, edited, and removed by users with suitable authorization (e.g., supervisor or administrator). Facilitator-administrative functions should generally be transparent to the caterer, airline, or other company.

Generally, substantial recurring system use is dependant on activities at the caterer level, as the caterer is responsible for physical inventorying of the pre and post-flight catering merchandise items as well as loading the POS devices with flight-specific information and unloading of the flight-specific sales transaction and inventory information. The catering users (i.e., flight kitchen employees) are generally blue-collar workers with little education and computer skills. To this end, the kitchen user interface is relatively simple and user-friendly to increase productivity, decrease training, decrease user errors, and the like. Referring to the “Kitchen” block of FIG. 6, the caterer user interface and portal functionality is described. Generally, the kitchen employees are responsible for loading (i.e., boarding) a flight with catering items 612, and unloading (i.e., deplaning) catering items from a flight 614. The flight boarding workflow is facilitated by an intuitive, user-friendly “wizard” user interface provided by the portal for the kitchen employee. All flights will have a default menu assigned to them. The interface may allows the user to add or remove items from the default menu as well as editing the pre-assigned default menu item quantities. A liquor kit number will be entered as necessary along with the cash bag number, starting cash amount and the estimated passenger start count. FIG. 7D illustrates an exemplary page displayed by the portal for selecting a flight to load. FIG. 7E illustrates an exemplary page displayed by the portal for entering liquor and cash information, and FIG. 7F illustrates an exemplary page for updating/editing default menu item quantities with physical pre-flight inventory information. The deplaning workflow is in many ways the reverse of the forgoing boarding process. Post-flight menu item quantities, cash amount, actual passenger count, etc. are recorded and the sales and inventory information is thereafter communicated to the portal and saved to the database 202. FIG. 7G illustrates an exemplary page for updating the post-flight inventory of menu item quantities, which information may later be employed for inventory and sales reconciliation.

Referring back to FIG. 6, the “Reports” block 630 is now described in further detail. As previously described in detail, the beginning item inventory information is entered into the database via the facilitator's Internet portal at the origination caterer/kitchen and downloaded to the POS devices. During the flight, attendants update inventory information and capture actual sales information on the devices. At the destination caterer/kitchen, the transaction data and attendant updated inventory information is uploaded from the devices, and ending sales proceeds and inventory information is entered into the database via the portal. The resulting data set is made available by the facilitator to authorized system users for reporting purposes. The facilitator may create a number of predefined reports based on this data and make the reports available on a secure area of the portal, or otherwise transmit the reports as necessary. A number of exemplary reports are hereafter described for illustrative purposes.

Flight Attendant Detail

The following report summarizes flight attendant sales activity by flight. A line item will be displayed for each attendant with sales activity on each flight. Each flight will be summarized with a flight total and each report execution will be summarized with a report total. User criteria for report execution will include flight#, attendant ID, product/category type and a date range. Flight# and attendant ID may be optional fields, while start and end dates are required. Product/category type will list the different product or category types (i.e. Liquor, headsets, etc).

All sales and quantity totals will be net of refunds. For example: Attendant 1 sells 4 items for $20 cash with transaction #1. Attendant 1 then refunds 1 of the 4 items sold in the previous transaction for $3 cash. The item quantity would=3, the cash would=$17 and the transaction quantity would equal 2. The comp column may include any type of discount for the transaction. This includes comps, coupons and frequent flyer discounts.

| Flight# | Date | Attendant | Cash | Credit | Comps | Item Qty | Trans Qty |
|---|---|---|---|---|---|---|---|
| 1 | MM/DD/YY | 999999999 | 20.00 | 50.00 | 15.00 | 15 | 5 |
| | | 888888888 | 10.00 | 45.00 | 10.00 | 9 | 3 |
| | | 777777777 | 25.00 | 30.00 | 25.00 | 11 | 5 |

| | | | | | |
|---|---|---|---|---|---|
| Flight Totals | 55.00 | 125.00 | 50.00 | 35 | 13 |

Discount Item Detail

The following report is a breakdown of each flight by item for discounted transactions. A line item will be displayed for each item that was discounted for any of the following reasons: comp, coupon, and frequent flyer. An item sales summary line will be displayed followed by a breakdown of discount types applied to the specified item. The item sales summary line will include sales totals for ALL transactions. Flight and report summary totals will also be displayed followed by the corresponding discount type breakdown. User criteria for report execution will include flight# and a date range. Flight# may be an optional field, while start and end dates are required. The discount column will reflect only the portion of the item that was discounted.

| Flight# | Date | Item | Gross | Discount | Net | Qty Sold | Discount Type | Discount |
|---|---|---|---|---|---|---|---|---|
| 1 | MM/DD/YY | Amaretto | 150.00 | 55.00 | 95.00 | 30 | First Class Comp | 20.00 |
| | | | | | | | Frequent Flier | 15.00 |
| | | | | | | | $5 off Order | 20.00 |

Another exemplary report is an inventory discrepancy report, which displays inventory counts from both the kitchen and the attendant. Discrepancies are calculated and displayed based on the inventory counts for reconciliation purposes. Yet another exemplary report is a frequent flier (FF) activity report, which displays frequent flier transaction details for each FF transaction that meets the criteria entered at execution. Other pre-configured reports may be available relative to credit card sales, sales inventory, transaction type by attendant, among other things. Additionally, items from related database tables may be queried to result in a custom view of requested data. The data may be presented in single or multi-dimensional views. Exemplary items that may be queried and included in customized, ad hoc, or pre-configured reports include:

TransactionID—Transaction identification number uniquely assigned to each transaction

Date—Date transaction is imported from hand-held to database

Time—Time transaction is imported from hand-held to database

EmployeeID—Flight attendant identification number

FlightNumber—Flight Number

CardNumber—Truncated credit card number

Member_Name—Card Holder Name if data is captured

TrasnType—Transaction type, Cash or Credit

ActionCode—Type of transaction, Sale or Refund

Swiped—Flag indicating whether transaction was magnetic stripe swiped or key entered

Auth_Amount—Credit Card authorized amount

Tax_Amount—Tax amount where applicable

Trans_Amount—Transaction total amount

Tip_Amount—Tip amount where applicable

Tender_Amount—Total amount of Cash tendered

Change_Amount—Total amount of change issued on Cash transactions

Issuer—Credit card issuer (e.g., Visa, Mastercard, American Express, Discover . . . )

Auth_code—Credit card authorization code

Status—Status of transaction (Pending, Completed, Open . . . )

Captured—Flag indicating that credit card transaction has been captured for settlement

Voided—Flag indicating that transaction has been voided

TransDate—Date transaction was entered into hand-held device

TransTime—Time transaction was entered into hand-held device

FF_Number—Frequent Flyer number where applicable

Seat_number—Passenger Seat Number

Coupon_Number—Flight Coupon Number

FF_Number—Frequent Flyer Number

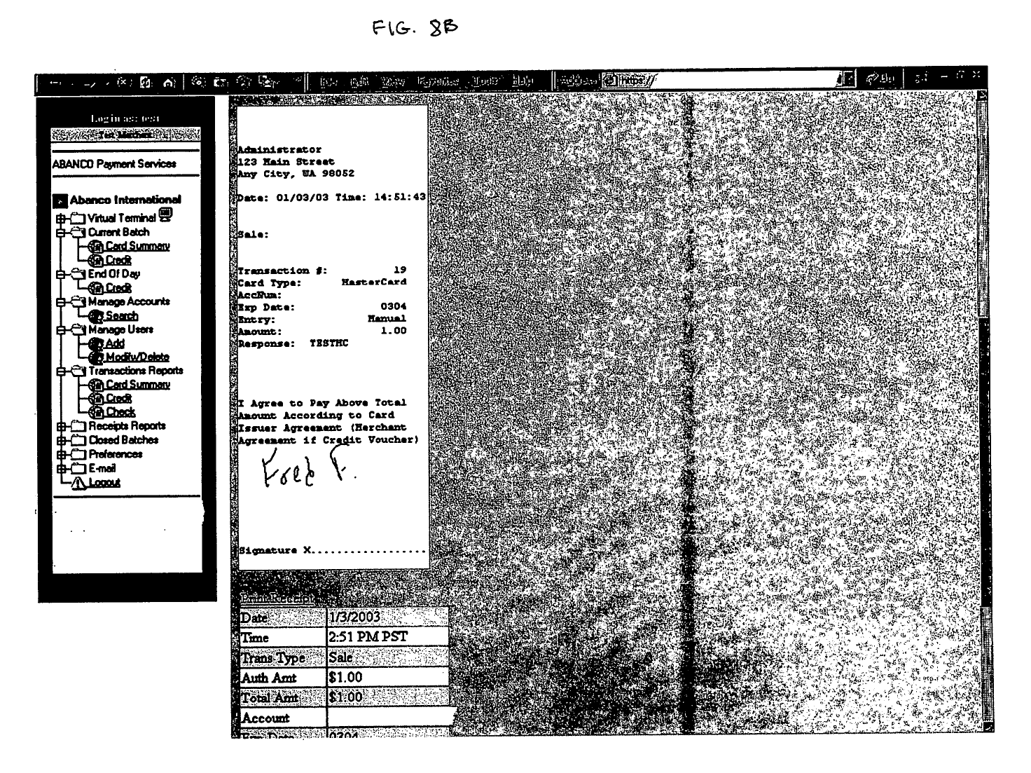

Reports can be delivered in numerous formats. One exemplary method of reporting is to access the transaction data via the Internet. Reports may be generated in HTML, XML or Tab delimited formats and downloaded via a secure connection, such as SSL. Additionally, payment data may be accessed via the Internet as the payment data is integrated into the database. As shown in FIG. 8A, one exemplary portal page illustrates a credit card report showing card authorization and settlement. It is contemplated that such payment services data may be accessed or otherwise made available to catering and/or airline financial personnel, separately from the inventory data, for purposes of sales reconciliation, account settlement, and the like. Moreover, as shown in FIG. 8B, in-flight sales transaction information, such as the captured electronic signature and receipt information may advantageously be archived for later retrieval. In one example, if a passenger were to contest a charge, by archiving a signature, the caterer and/or airline are provided with a measure of chargeback protection.

Preferred embodiments of this invention are described herein. The preferred embodiments are to be considered in all respects as illustrative and not restrictive. Variations of those preferred embodiments may become apparent to those of ordinary skill in the art upon reading the foregoing description. For example, in one exemplary embodiment where the airline has a partnership with a company located at the flight destination (e.g., a service provider, theme park, or the like), services available from that partner at the destination location may be purchased onboard by passengers at a discount. The purchasing passengers are provided with a voucher or receipt of payment which is verified or authenticated by the airline partner through use of an interactive voice response (IVR) system linked to the foregoing inventory and sales system. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for inventory and sales reconciliation for multiple scheduled events comprising:
an interface to an Internet portal in communication with a database for entering a collection of inventory items in the database for a selected one of the multiple scheduled events, the selected event occurring at a remote location;
a portable terminal for transport with the collection of inventory items to the remote location for collecting sales transactions information relating to sales of one or more of the inventory items to consumers; and
a report server for receiving information from the database and the portable terminal for reconciliation of the inventory items and sales transaction information after the selected event.

2. The system of claim 1 wherein the portable terminal collects consumer information during the sales transactions, the system further comprising:
a payment server for receiving the consumer information from the portable terminal for completing the sales transactions after the selected event, the payment server in communication with the report server; and
the report and payment servers using the inventory, and sales transactions information for completing business transactions with one or more owners of the inventory items.

3. The system of claim 2 wherein the selected event occurring at a remote location comprises a scheduled airline flight.

4. The system of claim 3 wherein the portable terminal comprises a personal digital assistant (PDA).

5. The system of claim 4 wherein the interface comprises a personal computer including a PDA cradle for downloading data to and uploading data from the PDA by synchronizing the PDA to the portal.

6. The system of claim 2 wherein the consumer information comprises credit card information, and the payment server is operative to route the card information to a financial network for transaction authorization and settlement.

7. The system of claim 6 wherein the payment server receives transaction settlement information from the financial network and communicates said settlement information to the database.

8. A system for in-flight sales transactions and inventory control comprising:
a back-office subsystem including at least one server and a database for storing a plurality of flight profiles and completed flight information,
an administrative user interface in communication with the back-office subsystem for inputting and maintaining the profiles;
an end-user interface in communication with the back-office subsystem for inputting the completed flight information; and
an in-flight terminal device for completing sales transactions and tracking onboard inventory items.

9. The system of claim 8 wherein the at least one server comprises:
an application server in communication with the Internet for providing access to an Internet portal application;
a report server in communication with the application server and database for providing completed flight information; and
a payment server linking the application and report servers to a financial processing network.

10. The system of claim 8 wherein the in-flight terminal device comprises a personal digital assistant (PDA).

11. The system of claim 10 wherein the end-user interface comprises a personal computer including a PDA cradle for downloading data to and uploading data from the PDA by synchronizing the PDA to the application server.

12. The system of claim 10 wherein the PDA comprises:
a touch sensitive interface screen;
a printer for printing records of sales transactions; and
a magnetic card strip reader for inputting card information into the PDA.

13. The system of claim 8 wherein a flight profile comprises flight information for a predefined and scheduled airline flight, and a default list of items to be sold onboard the flight.

13. The system of claim 10 wherein the completed flight information comprises sales transaction information and inventory information.

14. A method for completing sales transactions on moving vehicles and for tracking sales inventory, the method comprising:
linking, at the vehicle origination location, a portable device to a terminal having an operating system for pre-sale configuration;
loading, at the vehicle origination location, base criteria from the terminal into the portable device;
completing, onboard the vehicle, sales transactions and inventory tracking with the portable device;
linking, at the vehicle destination location, the portable device to a terminal having an operating system for post-sale synchronization;
loading, at the vehicle destination location, sales transaction data from the portable device into the terminal; and
routing sales transaction data from the terminal to a database for creation of sales and inventory reports.

15. The method of claim 14 wherein the completing step further comprises:
inputting sales transaction data into the portable device via a touchscreen display;
calculating the total cost of the sales transaction;
accepting payment for the sales transaction; and
updating the count of inventory items.

16. The method of claim 15 wherein the accepting step further comprises:
swiping a card;
storing the swiped card information; and
printing a receipt for the sales transaction.

17. The method of claim 16 further comprising the step of capturing an electronic signature of the cardholder via the touchscreen display.

18. The method of claim 16 further comprising the steps of:
transmitting the stored swiped card information to a financial processing network;
receiving card authorization and settlement information from the financial processing network relative to the swiped card information; and
routing the authorization and settlement information to the database.

19. The method of claim 14 wherein the method further comprises the steps of:
inventorying, at the vehicle destination location, the remaining sales inventory; and
entering, at the vehicle destination location, the remaining sales inventory information into the terminal.

20. The method of claim 14 wherein the moving vehicle comprises a passenger aircraft.
